(19) United States
(12) Patent Application Publication
(10) Pub. No.: US 2012/0302307 A1
(43) Pub. Date: Nov. 29, 2012

(54) NOVEL SIDE BET GAME WITH ROULETTE PLAY

(76) Inventor: Jamie Abrahamson, New York, NY (US)

(21) Appl. No.: 13/114,598

(22) Filed: May 24, 2011

(51) Int. Cl. A63F 13/00; A63F 5/00

(52) U.S. Cl. 463/17; 273/274

(57) ABSTRACT

A method of playing a roulette game with a side bet uses:
a) a dealer accepting a wager on a side bet in a roulette game;
b) the dealer causing an outcome in a roulette game by allowing a random event of a ball drop in a numbered roulette wheel to occur;
c) the dealer indicating a first final event in the outcome of a roulette game as a single number outcome of a ball drop in a numbered slot in the roulette wheel;
d) the dealer resolving any underlying wagers in the roulette game; and
e) the dealer resolving the wager on the side bet in the roulette game.

The side bet is resolved according to a paytable after at least two consecutive outcomes and after no more than three consecutive outcomes according to event outcomes selected from the group consisting of:
f) determining outcomes in the side bet are based on summing digits in roulette number outcomes or by normalizing digits in roulette number outcomes to a last digit only;
   paytable outcomes for the side bet pay awards on events comprising 1) three determining outcomes having a consecutive sequence of values; 2) three determining outcomes having a consecutive sequence of values and a same color; 3) three determining outcomes having a same value; 4) three determining outcomes having a same value and a same color.

### BACKGROUND OF THE INVENTION

1. Field of the Invention

The present invention relates to the field of casino gaming, particularly for roulette gaming, and more particularly for side bets in roulette games.

2. Background of the Art

There are a few games at casinos and on the internet in which the availability of a significant variety of wagers may intimidate new players from the game. For example, roulette has at least 13 different types of wagers, without counting individual numbers or similar compilations of numbers (e.g., adjacent numbers, lines of numbers, boxes of numbers, etc.) as different types of wagers. Craps also has at least 8 different wagering option that are not printed on the table layout. The fact that players will not play the game or are limited in the scope of their wagers because of the intimidation factor lowers the profits of casinos.

With the advent of electronic wagering systems, on fully automatic video systems, partially combined live facilities and electronic wagering, or completely live systems with electronic wagering, the games can be played more quickly, but the intimidation factor remains present for some players.

Side bet games have become very popular in casino games and have been used in most games, including roulette games.

U.S. Pat. No. 7,614,624 (Kling) discloses a modified roulette game wherein a plurality of values are selected and analyzed during each round of play. A set of predetermined playing cards is used to determine values that determine the outcome of bets. The gaming method includes: dealing a plurality of community cards from a predetermined set of cards and using a predetermined community card (e.g., last card dealt) to determine the result of all roulette-type bets. The player may also make optional side bets based on the outcome of two or more of the community cards dealt (e.g., that the community cards will form a winning poker combination (poker-type bet) or that the first and last community cards dealt will be jokers (Wild Viking bet)). A gaming layout is also disclosed and includes a plurality of betting positions that correspond to the predetermined set of cards, the poker type bets, and other types of possible bets.

Published U.S. Patent Application Document No. 20090102119 (Kling) discloses a gaming apparatus includes a roulette ball; a roulette wheel a basic conventional roulette betting area; and an additional betting area comprised of ten positions, each designating numbers ending in 0, 1, 2, 3, 4, 5, 6, 7, 8, or 9. In alternate embodiments, the additional betting area includes a first block, second block, and third block designating numbers ending in 1, 2, or 3; 4, 5, or 6; and 7, 8, or 9 respectively. The additional betting area may further include a black-even space, a red-even space, a black-odd space; and a red-odd space. A method of playing roulette comprises providing a roulette gaming apparatus of the present invention, allowing each player to place at least one bet on the basic roulette betting area and at least one extra bet on the additional betting area, wherein the at least one extra bet may be any multiple of a minimum wager; and resolving bets according to the number spun on the roulette wheel.

Published U.S. Patent Application Document No. 20080113706 describes a wagering system for a wagering game uses at least one live random outcome game piece in the play of the wagering game. A gaming table is used with at least one game piece to determine a random outcome. At least two player interface wagering systems with a visual display are provided on each player interface wagering system. Each player interface wagering system is in communication link with a game server that processes game data and determines wager outcomes. Each player interface wagering system has at least two selectable wagering input displays that may be separately selected and displayed by a player wagering at each player interface. Each of the at least two selectable wagering input displays identifies different sets of wagers that may be placed by the player on the random outcomes of the wagering game.

U.S. Pat. No. 7,637,503 (Sorge) discloses a roulette game including a board game surface and roulette wheel, wherein besides the traditional roulette wheel wagering opportunities, an additional novel wagering area is provided for additional “side betting.” That is, a side wagering area comprising ten individual wagering areas corresponding to a digit value 0, . . . , 9, is provided for the game board surface. A bettor may conduct a wager by placing a chip or marker on a particular digit value of the side wagering area for indicating a wager that a resulting digit of a one digit or two digit whole number roulette spin outcome will match that digit value being wagered. The payout odds for a winning side bet adheres to house advantages established for both American and European style roulette games.

U.S. Pat. No. 5,540,442 (Orselli) describes a modified roulette game offering an additional betting opportunity with a large payoff for a winning bet. A player, having made a conventional roulette bet on a conventional roulette betting layout, may make a second or side bet on a related betting layout exhibiting only the numbers of the conventional roulette betting layout, without regard to color, parity or position. When the winning bets in the conventional layout are determined by the operation of the roulette wheel, a random number generator also generates and displays one of the conventional roulette numbers, i.e., 1-36, 0 or 00. If the number displayed by the random number generator is the same as the winning number that is determined by the roulette wheel, the side bet on that number is a winning bet.

### SUMMARY OF THE INVENTION

A method of playing a roulette game with a side bet uses:
a) a dealer accepting a wager on a side bet in a roulette game;
b) the dealer causing an outcome in a roulette game by allowing a random event of a ball drop in a numbered roulette wheel to occur;
c) the dealer indicating a first final event in the outcome of a roulette game as a single number outcome of a ball drop in a numbered slot in the roulette wheel;
d) the dealer resolving any underlying wagers in the roulette game; and
e) the dealer resolving the wager on the side bet in the roulette game.
   The side bet is resolved according to a paytable after at least two consecutive outcomes and after no more than three consecutive outcomes according to event outcomes selected from the group consisting of:
f) determining outcomes in the side bet are based on summing digits in roulette number outcomes or by normalizing digits in roulette number outcomes to a last digit only;
   paytable outcomes for the side bet pay awards on events comprising 1) three determining outcomes having a consecutive sequence of values; 2) three determining outcomes having a consecutive sequence of values and a same color; 3) three determining outcomes having a same value; 4) three determining outcomes having a same value and a same color.

An electronic wagering system is also disclosed in which at least seven distinct types of wagers can be placed.

### BRIEF DESCRIPTION OF THE FIGURES

FIG. 1 shows a perspective view of an electronic gaming table designed for implementation of a roulette game with dealer input, physical roulette wheel, individual player terminals and visual display device.

FIG. 2 shows a schematic of a player input and system management network for an electronic gaming system supporting methods according to the present invention.

FIG. 2A shows a monitor screen shot of a low level of complexity wagering screen for roulette.

FIG. 3 shows a monitor screen shot of a higher level of complexity wagering screen for roulette.

FIG. 3A shows a player's terminal display of a screen shot of a wagering board for a casino table roulette game.

FIG. 4 shows a flow chart for use of the system of the present technology using monetary inputs (currency) into the system, accepting credit, selecting a preferred wagering profile and then placing wagers.

### DETAILED DESCRIPTION OF THE INVENTION

A method is used to play a roulette game with a side bet. The game may be played on a completely physical gaming table, a blend of a physical gaming table (with at least a roulette wheel and ball that drops into the slots or canoes of the wheel with numbers thereon), or an electronic game having a processor, player terminals, and video display showing virtual roulette outcomes and displaying other game related information. The method may include steps such as:
a) a dealer accepting a wager on a side bet in a roulette game (the side bet wager being either physically placed on the gaming table or entered into a player wagering terminal);
b) the dealer causing an outcome in a roulette game by allowing a random even of a ball drop in a numbered roulette wheel to occur (the outcome may be done by the dealer initiating wheel spinning (or allowing automatic wheel spinning) and dropping a ball onto the wheel frame (this may also be done automatically) or performed virtually by a processor executing software code that produces random outcomes equivalent to selection of roulette ball drop outcomes;
c) the dealer indicating a first final event in the outcome of a roulette game as a single number outcome of a ball drop in a numbered slot in the roulette wheel (the dealer may indicate the outcome by automatic reading of a ball drop which is relayed to a processor, by the dealer inputting the results of a physical ball drop into a dealer terminal or by the processor identifying the result of the virtual random generated outcome);
d) the dealer resolving any underlying wagers in the roulette game (where the “dealer” is effectively a processor in this step and wagers have been electronically entered, the processor-dealer resolves the wagers in an electronic accounting system for the respective players); and
e) the dealer resolving the wager on the side bet (again, this may be an electronic wager resolution with the processor acting as a dealer in this aspect) in the roulette game as follows:
   the side bet is resolved according to a paytable after at least two consecutive outcomes and after no more than three consecutive outcomes according to event outcomes selected from the group consisting of:
i) determining outcomes in the side bet are based on summing digits in roulette number outcomes or by normalizing digits in roulette number outcomes to a last digit only (by summing digits it is meant that 10 becomes 1 [1+0=1]; 11 becomes 2 {1+1=2]; 13 becomes 4 [1+3=4], 24 becomes 6 [2+4=6], 29 becomes 1 [2+9=11 which is normalized to 1] so that the total number of determined outcomes of the numbers in the side bet remains at 10 (1, 2, 3, 4, 5, 6, 7, 8, 9 and 0) (0 may remain as 0, including the wild (00). ‘0’ may be considered ‘0’ and ‘00’ may be considered ‘wild’ for both methods) and the two 0's, 0 and 00.
ii) paytable outcomes for the side bet pay awards on events comprising 1) three determining outcomes having a consecutive sequence of values; 2) three determining outcomes having a consecutive sequence of values and a same color; 3) three determining outcomes having a same value; 4) three determining outcomes having a same value and a same color. Normalization means that all number outcomes on the roulette spin (except for 0 and 00) are determined as the last digit in the number so that (0-9 are 0-9, respectively) and 1-9 are 1-9, respectively, and 10-19 are 0-9 respectively, and 20-29 are 0-9 respectively and 30-36 are 0-6 respectively. (00 is wild, 0 included above as 0) 0 and 00 (00 becomes wild remain as those numbers and outcomes in the game).
   In the practice of this method, the determining outcome may be made by the dealer on a basis of normalized numbers using only the last digit in the roulette outcome to determine an outcome value (as explained above). The numbers may be generated by a physical roulette wheel and physical ball are used by the dealer to create the outcome in the roulette game or where a random number generator is used by a processor to randomly determine virtual outcomes that are subsequently displayed on a video display. As previously noted, the dealer may accept wagers only on an electric terminal associated with a roulette gaming table and the dealer resolves wagers through a processor that executes code in software to determine winning outcomes on any underlying roulette wagers and the side bet wager.

In the practice of this method, the side bet wager may be resolved after two determining outcomes only when the first two determining outcomes are incapable of providing a winning outcome. It is more desirable to allow all three outcomes to occur, but this intermediate step may be performed, especially with the added security of resolution by a processor, which would minimize errors. Typically, the side bet wager is always resolved after three determining outcomes.

The method may be practiced where a portion of the side bet is contributed to a progressive jackpot fund and determined outcomes in the side bet game are used to determine winning outcomes in the progressive jackpot game. The amount of the progressive jackpot may be displayed on a monitor (such as a typical pole monitor) by the table. The jackpot winning outcome may be based on a paytable incorporated in or independent from the side bet paytable. For example, the jackpot may pay out 100% of the jackpot for consecutive events of 00-00-00, a lesser percent (e.g., 10-25%) for 0-0-0 and lesser amounts (percentages or absolute dollar amounts decremented from the jackpot amount) for 0-00-0, 00-0-00, 00-00-0, 0-0-00, and the like).

The gaming method should have wheels that allow 0 (only as in European roulette wheels), only 00 or wheel outcomes include both a 0 and a 00 outcome as is typical in the United States. The results of individual roulette outcomes are preferably displayed on a visual display such as a monitor, pole monitor, pole display or commonly viewable screen. The determined outcomes are displayed and may be emphasized by display of the roulette outcomes. The emphasis can be done by flashing the last digit, separately displaying the last digit in 1, 2 or 3 running game displays.

The method may be practiced with at least three side bet wager games simultaneously in play using three different sets of three determined outcomes. For example, when one side bet wager is running on the third spin, two other games may be running on a second spin and a first spin. The wagers and outcomes should be identified separately, as by separate display areas on the outcome display systems.

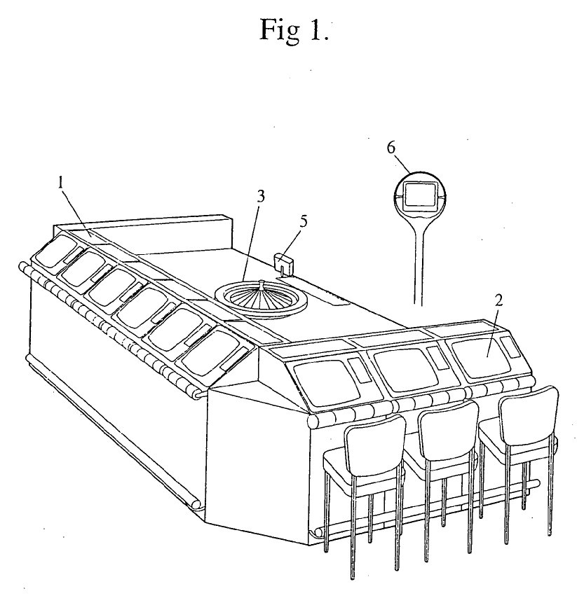

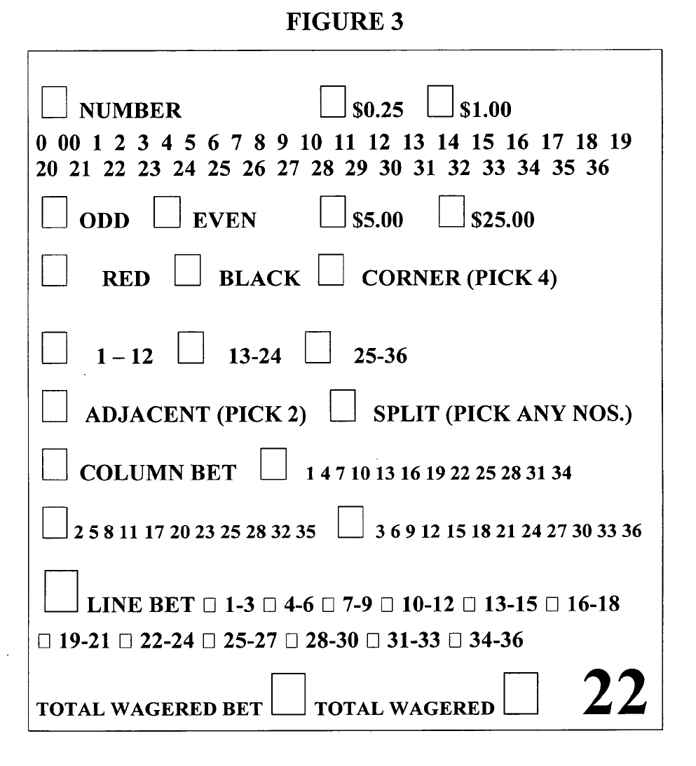

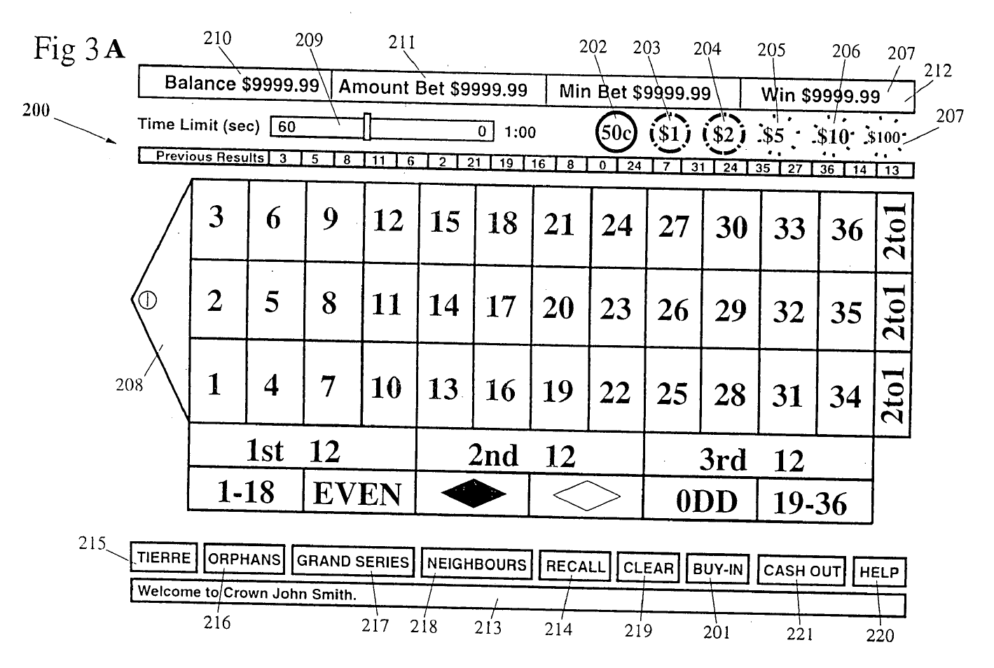

An apparatus can be configured (as described in greater detail above) to enable practice of the method comprising the system shown in FIG. 1. Shown is a gaming table 1, a roulette wheel 3, a roulette ball (not shown), and a surface displaying wagering positions (See FIG. 3A) for wagers on the roulette game and a separate area for wagering on the side bet and a display 6 indicating status of determined outcomes on the side bet wager. Alternatively there may be an apparatus configured to enable practice of the method comprising a gaming table 1, a roulette wheel 3, a roulette ball (not shown), a dealer input terminal 5 and player input terminals 2 for placing wagers on the roulette game and the side bet and a surface displaying wagering positions for wagers on the roulette game (See FIG. 3A) and a display indicating status of determined outcomes on the side bet wager 6.

The complexity of the wagering and payouts is also addressed by the proposed system, as upon entering of ball drop results, the payouts can be made by a processor. The processor may initiate a display on the individual player's screen 132 showing the results of individual wagers. To enhance this effect, a screen may be shown with the individual types of wagers made by each player, an adjacent numeric showing the amount of value placed on that wager, and a resulting display of the amount of the payout on that winning wager or an indication of the loss of that wager can be highlighted, displayed or announced on the screen 2. Players may be asked if they wish to replace particular wagers, especially if those wagers (now removed) have been part of the past wagering profile of particular players.

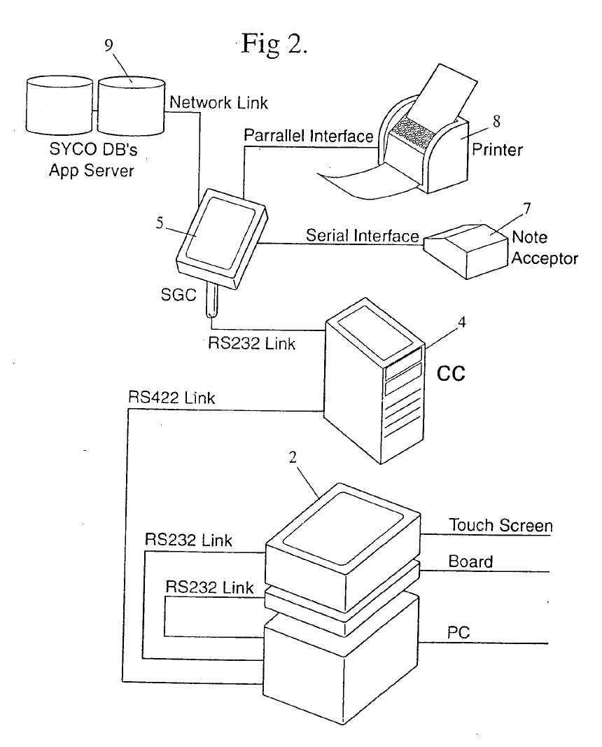

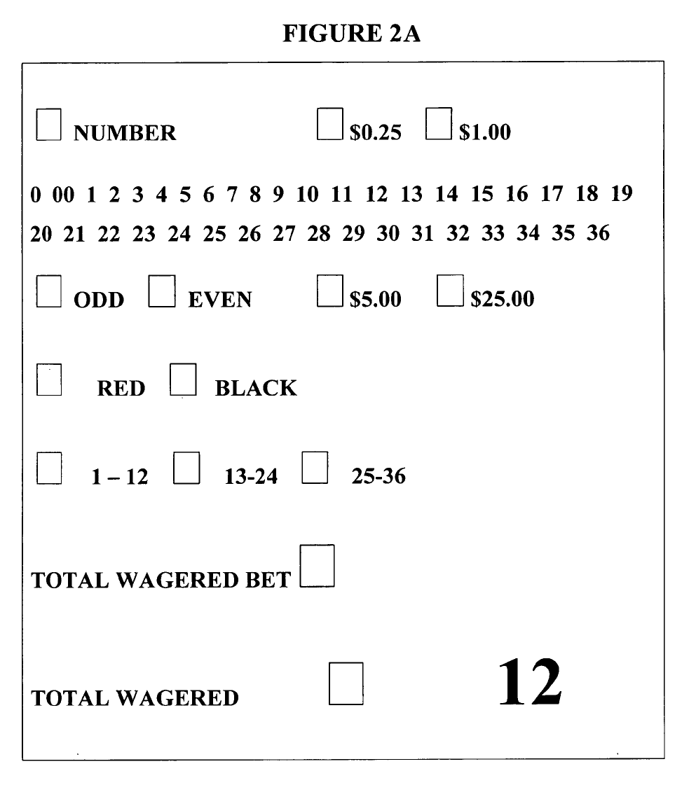

One aspect of the technology described herein may be generally referred to as a wagering system for a wagering game using at least one live random outcome game piece in the play of the wagering game. The system may at least comprise a gaming table on which the at least one physical game piece (wheel and ball) is used to determine a random outcome. The system includes at least two player interface wagering systems 2, with a visual display provided on each player interface wagering system. Each player interface wagering system is in communication linkage with a game server (not shown) that processes game data and determines wager outcomes. But see FIG. 2 for the electronic schematic showing the network link 9, printer (optional) 8, server gaming controller (SGC 5), central computer (CC 4) and touchscreens 2 with links. Each player interface wagering system has at least two distinct, selectable wagering input displays that may be separately selected and displayed by a player wagering at each player interface. Each of the at least two distinct, selectable wagering input displays identifies different sets of wagers that may be placed by the player on the random outcomes of the wagering game. Each of the at least two selectable wagering input displays can display at least four separate wagers that a player may enter in the random outcomes of the wagering game. An exemplary wagering system may provide each player interface wagering system with at least three selectable wagering input displays that may be separately selected and displayed by a player wagering at each player interface. The player at a player interface wagering system may tailor at least one selectable wagering input display by entering or deleting wagers that are allowed in play of the random outcome wagering game. The wagering game may provide the at least one game piece as a roulette ball and a roulette wheel.

In what is referred to herein as a live or partially live game, a dealer input panel may be used by a dealer to manually input random outcomes to the game server or game controller to indicate outcomes for the game processor to use in determining wager outcomes, as opposed to automated reading of the random events, which is another option in the design of the systems. A method of playing may require that after players have placed their wagers, the dealer manually locks out further wagers before the random outcome game piece completes determination of a random event. The method may also have a player modify at least one second selectable wagering input display to form a personalized player wagering screen and that player places a wager on the wagering game using the personalized wagering screen.

Wagering may be done on these systems by cash input to the system to establish an account, establishing an individual player account with the wagering facility and accessing the account through the game processor or other processor at the table, using a credit card, inserting a ticket representing monetary value (ticket-in, ticket-out type technology); inserting casino gaming chips into a counter or register, paying cash to the dealer and establishing a credit at each player interface, and the like.

FIG. 2A shows a monitor screen shot 12 of a low level of complexity wagering screen for roulette. The screen shot 12 is shown as a touchscreen, where individual pressure points on the alphanumerics are used to enter wager. The simplest wagers are entered by, for example, by pressing the number wager pressure point NUMBER and then pressing one number at a time selected from 0 00 1 2 3 4 5 6 7 8 9 10 11 12 13 14 15 16 17 18 19 20 21 22 23 24 25 26 27 28 29 30 31 32 33 34 35 36. After selecting a single number, the amount of the wager is entered by pressing pressure points on the available wager amounts, $0.25, $1.00, $5.00, $25.00 with intermediate wager amounts (such as $12.75) being made by pushing $5.00 twice, $1.00 twice and $0.25 three times. The total wagered bet on a single gaming event can be displayed in a display area such as TOTAL WAGERED BET. Other simple wagers can be entered in similar manners by individually pressing the other wager types shown. RED, BLACK, ODD, EVEN, 1-12, 13-24, and 25-36 and individually entering the amount of the wager desired. This individual wager total will gain be shown in the Total Wagered Bet area, while a separate display area may show the cumulative total wagers on the individual bets as TOTAL WAGERED.

FIG. 3 shows a monitor screen shot 22 of a higher level of complexity wagering screen for roulette, with all of the wagers shown in FIG. 2, plus additional wagers.

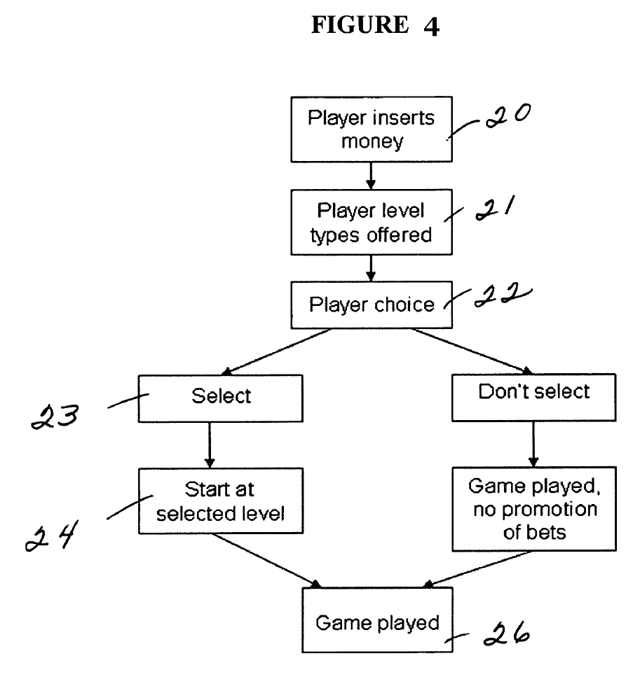

FIG. 4 shows a flow chart for use of the system of the present technology using monetary inputs (currency) into the system, accepting credit, selecting a preferred wagering profile and then placing a wager. Each level has some pre-determined bet offerings that allows players shortcuts in the play. The Novice level will offer the simplest bet levels and highlight them to the player, or offer a shortcut to place a nominated bet. The next level of the invention is determining the level of the player, and then offering shortcuts that emulate what a player may do. The vagaries of the game are such that players may wish to parlay one bet into another, or take off some money once a certain event occurs. There may also be instances where more contrarian players are offered some hedging bet options to protect earlier, more successful bets. The flowchart below tracks this through each step of the game.

FIG. 4 shows a flow chart for further play on the technology described herein. In this flowchart, the game is started 20, and the main available wagers are highlighted 21 or at least displayed on the player's selected wagering screen as player's choices 22. The player places wagers 20 by touch screen entry. A processor receives the bets, evaluates the bets 23 and the play continues 24. After a number of rolls, the processor may signal the player through the screen that other wagers or other levels may be available from which the player should consider wagers. This can be done on a rote manner, with certain wagers promoted based on the general level of play of the individual, or the processor may evaluate the roll or event history, display the roll or event history, and imply to the player that certain additional wagers seem to be indicated on the basis of ball number history and events.

As players proceed through the game, the unit assesses their bet level 36 and may assign a level to that particular player. To promote further play of the game and a better understanding, further bets from the next level are offered after every X games. The reference of the next level may assign players a level based on bets being made. Such a table may look something like the following:

Although one skilled in the art would be aware of the underlying nature of hardware and software that would be used in systems such as those described herein, a further specific description of presently preferred system requirements is provided.

### Hardware Considerations

An interface between a Dealer PC and the display controller is provided to receive bets placed by the player terminals in real time and send them to the display to be represented on display screen. 2. A display controller may be used to create a 3d graphical representation of chips stacked as they would be on a live table. 3. An intelligent sound system can be used to interface with the game controller and display controller to play different sounds and sound volumes depending on what stage and state of play the game is in. 4. Includes speakers and a subwoofer in the table to vibrate the table and give it feel at certain points in the game. Moderate size such as 10 inch″ (25.4 cm) touch screens may be connected to the roulette table with a layout of the game for the players to interact with the game. 5. Serial Card reader can be provided for players to insert rating cards which are logged in the Rapid Database. 6. A dealer PC may be provided that the dealer operates to start the game, enter results, buy in players, cashout players and open/close the table. 7. Server PC with SQL database can be provided. 8. BOH PC with Reporting and configuration utility can be provided. 9. A relatively larger 26 inch (65 cm) LCD screen or other monitor can be used for Display or results, histories, and other information. 10. A steel frame Roulette Table designed to be enclosed to house peripheral equipment under the playing surface and have the 10 inch (25.4 cm) touch screens attached can be provided as a standard equipment piece.

Software Consideration

1. SQL Database for holding game configuration and game data and player ratings can be provided into the system. 2. Table Configuration software to configure odds, table layout, betting positions, commission value, table maximum and minimum, bet position maximum and minimum as well as chip values should be provided in the system. 3. Reporting software, for reporting to central auditing, record keeping, player comping, central finance area can and should be provided. 4. SGC software to allow the dealer to start the game, enter the result, confirm the result, open/close the table, buy in players, cash out players and disable/enable player terminals should be provided in the system. 5. Terminal Software to show the table layout on the 10 inch (25.4 cm) LCD Touch screens and allow the player to interact with the game are preferred, although table menu prints of wagers are acceptable. The layout on the terminal may have various magnification points to allow the players better access to betting positions represented on the small screen, either upon demand or automatically as wagers are being placed in particular areas of the table layout image. There may also be prompting configured into the terminal software to allow new players to follow the game by graying out area's on the screen where a bet cannot be placed or prompting players to move bets to positions with better odds. There is also an in depth help function that players can follow on game rules, common roulette terminology and betting positions. 6. Game Controller software to catch or read bet positions and values from player terminals as they are received by the SGC and send them to the display controller in real time. 7. Display software may be provided on the display controller PC with the capability on showing the game play in real time on a 3d representation of the game table along with a number tree of previous results of individual events and ball drops and animation of ball drops and wheel spins, table open and closed.

A typical paytable, used as a non-limiting example in the practice of the present gaming technology could be:

Pay Table

| Outcome | | Payout |
|---|---|---|
| 3 WILDS | | TBD |
| 3 of a Kind | (7s-9s) | TBD |
| 3 of a Kind | (0s-6s) | TBD |
| Color Straight | (7-8-9) | TBD |
| Color Straight | (All others) | TBD |
| Straight | (7-8-9) | TBD |
| Straight | (All others) | TBD |
| Pair | (7s-9s) | TBD |

TBD is “To Be Determined”
Only highest Payout pays
‘0’ is considered low only for Straights
A Color Straight wins when all 3 values in the straight are the same color

It is of course within the skill of the artisan to add additional components to the paytable, such as consecutive numbers consecutively resulting from spins, and either increasing or decreasing in value (e.g., 7-8-9 or 9-8-7 being differentiated). It is to be noted that the disclosed paytable uses only 7's, 8's and 9's as one category of straight, but that is merely exemplary. All straights, all three-of-a-kinds, all same color combination and other specific predetermined combinations of cards may be used in a paytable. The 7-8-9 straight is separated because of the probability differences between that particular straight and other straights. A general payout for any straight may be used wherein there is a single payout for any straight as the variability between specific straights can be built into the “average” probability and resulting odds in the payout. In other words, there need not be different payouts for different straights, but there may be a single payout identified in the paytable, even though individual straights may have different probabilities. In the ‘summing’ method there are fewer 0s 1s and 2s and so there would be different probabilities for straights with those numbers. The payout odds could be similarly addressed, if wagers on different straights were available (numbers for which there are only 3 available roulette outcomes, e.g., from 9, 19 and 29, as there is no 39, while (1's-5's or (0s-6s) have four available outcomes, as from 1, 11, 21 and 31). It is within the skill of the artisan to have wagers available on determined normalized or summation outcomes of 0, 1, 2, 3, 4, 5 and 6 (while 0 and 00 might be excluded from the individual spin outcomes (0 is never excluded . . . its is always 0) that can be used for determining determined outcomes for the return on the wager on those numbers even further adjusted (as noted above 0 and 00 are included). For example, on 3-of-a-kind for 7, 8 or 9, the return might be 50:1, while the return for 1, 2, 3, 4, 5 or 6 (or 0-6) might be 40:1. Similarly, the return on a straight of 7-8-9 in any order might be 40:1 and a straight on any other straight including consecutive numbers of 1 2 3 4 5 6 (or 0-6) might be 30:1. The payout may be varied according to the absolute probabilities of the events and then adjusted to effect a desired level of house return.

1) A method of playing a roulette game with a side bet comprising:
a) a dealer accepting a wager on a side bet in a roulette game played with a physical spinning roulette wheel and roulette ball;
b) the dealer causing an outcome in a roulette game by allowing a random event of a ball drop to occur in the spinning roulette wheel which is a numbered roulette wheel;
c) the dealer indicating a first final event in the outcome of the roulette game as a single number outcome of a ball drop in a numbered slot in the roulette wheel;
d) the dealer resolving any underlying wagers in the roulette game; and
e) the dealer resolving the wager on the side bet in the roulette game as follows:
the side bet is resolved according to a paytable after at least two consecutive outcomes and after no more than three consecutive outcomes according to event outcomes selected from the group consisting of:
i) determining outcomes in the side bet are based on summing digits in roulette number outcomes or by normalizing digits in roulette number outcomes to a last digit only; and
ii) paytable outcomes for the side bet pay awards on events comprising 1) three determining outcomes having a consecutive sequence of summed digit values; 2) three determining values having a consecutive sequence of summed digit values and a same color; three determining values having a same summed digit value; and three determining outcomes having a same summed digit value and a same color.

2) The method of claim 1 wherein the determining outcome is made by the dealer on a basis of normalized numbers using only the last digit in the roulette outcome to determine an outcome value and both i) and ii) are considered in resolving all side bet outcomes.

3) The method of claim 2 wherein a physical roulette wheel and physical ball are used by the dealer to create the outcome in the roulette game by allowing the roulette ball to drop into a single ball catch slot in the spinning roulette wheel.

4) The method of claim 3 wherein the dealer accepts wagers only on an electric terminal associated with a roulette gaming table and the dealer resolves wagers through a processor that executes code in software to determine winning outcomes on any underlying roulette wagers and the side bet wager.

5) The method of claim 1 wherein the side bet wager is resolved after two determining outcomes only when the first two determining wagers are incapable of providing a winning outcome and both i) and ii) are considered in resolving all side bet outcomes.

6) The method of claim 1 wherein the side bet wager is always resolved after three determining outcomes and both i) and ii) are considered in resolving all side bet outcomes.

7) The method of claim 5 wherein a portion of the side bet is contributed to a progressive jackpot fund and determined outcomes in the side bet game are used to determine winning outcomes in the progressive jackpot game.

8) The method of claim 6 wherein a portion of the side bet is contributed to a progressive jackpot fund and determined outcomes in the side bet game are used to determine winning outcomes in the progressive jackpot game.

9) The method of claim 3 wherein wheel outcomes include both a 0 and 00 outcome and the numbers 0 and 00 are present as available slot positions on the roulette wheel.

10) The method of claim 4 wherein wheel outcomes include both a 0 and 00 outcome and the numbers 0 and 00 are present as available slot positions on the roulette wheel.

11) The method of claim 3 wherein results of roulette outcomes are displayed on a visual display.

12) The method of claim 4 wherein results of roulette outcomes are displayed on a visual display.

13) The method of claim 11 wherein the determined outcomes are emphasized by display of the roulette outcomes.

14) The method of claim 12 wherein the determined outcomes are emphasized by display of the roulette outcomes.

15) The method of claim 3 wherein at least three side bet wager games are simultaneously in play using three different sets of three determined outcomes on the same physical roulette wheel.

16) The method of claim 4 wherein at least three side bet wager games are simultaneously in play using three different sets of three determined outcomes on the same physical roulette wheel.

17) The method of claim 6 wherein at least three side bet wager games are simultaneously in play using three different sets of three determined outcomes on the same physical roulette wheel.

18) The method of claim 7 wherein at least three side bet wager games are simultaneously in play using three different sets of three determined outcomes on the same roulette wheel.

19) An apparatus configured to enable practice of the method of claim 3 comprising a gaming table, a roulette wheel, a roulette ball, and a surface displaying wagering positions for wager on the roulette game and a separate area for wagering on the side bet and a display indicating status of determined outcomes on the side bet wager.

20) An apparatus configured to enable practice of the method of claim 3 comprising a gaming table, a roulette wheel, a roulette ball, a dealer input terminal and player input terminals for placing wagers on the roulette game and the side bet and a surface displaying wagering positions for wagers on the roulette game and a display indicating status of determined outcomes on the side bet wager.

21) A method of playing a roulette game on an electronic gaming system with a side bet comprising:
a) a processor acting as a dealer, the processor accepting a wager on a side bet in a roulette game played with a virtual spinning roulette wheel and virtual roulette ball;
b) the dealer causing an outcome in a roulette game by executing software to simulate a random event of a virtual ball drop to occur in the virtual spinning roulette wheel which is a virtual numbered roulette wheel;
c) the dealer indicating a first final event in the outcome of the roulette game as a single number outcome of a virtual ball drop in a numbered slot in the virtual roulette wheel;
d) the dealer resolving any underlying wagers in the roulette game; and
e) the dealer resolving the wager on the side bet in the roulette game as follows:
the side bet is resolved according to a paytable after at least two consecutive outcomes and after no more than three consecutive outcomes according to event outcomes selected from the group consisting of:
i) determining outcomes in the side bet are based on summing digits in roulette number outcomes or by normalizing digits in roulette number outcomes to a last digit only;
ii) paytable outcomes for the side bet pay awards on events comprising 1) three determining outcomes having a consecutive sequence of values; 2) three determining values having a consecutive sequence of values and a same color; three determining values having a same value; and three determining outcomes having a same value and a same color.
